(19) United States
(12) Patent Application Publication
(10) Pub. No.: US 2016/0203207 A1
(43) Pub. Date: Jul. 14, 2016

(54) ELECTRONIC APPARATUS AND CLASSIFYING METHOD

(71) Applicant: HTC Corporation, Taoyuan City (TW)

(72) Inventors: Chia-Yin LU, Taoyuan City (TW); You-Lin SONG, Taoyuan City (TW)

(21) Appl. No.: 14/594,175

(22) Filed: Jan. 12, 2015

(51) Int. Cl. G06F 17/30

(52) U.S. Cl. CPC G06F 17/30598; G06F 17/30554

(57) ABSTRACT

A classifying method adapted to an electronic apparatus is disclosed. The classifying method includes following steps: according to frequency counts of executing plural application programs in the electronic apparatus, correspondingly creating plural data folders in at least one storage device; and classifying data in the at least one storage device into at least one of the data folders according to contents of the data.

### BACKGROUND

1. Field of Invention

The present disclosure relates to a classifying method. More particularly, the present disclosure relates to a method of automatically classifying data and an electronic apparatus.

2. Description of Related Art

With the development of mobile electronic apparatuses, application programs in the electronic apparatus are getting more and more diversified, such as application programs of information browsing (BlinkFeed), web browsing (Chrome, Firefox or Safari), social networking (Facebook or Weibo), health care, and weather broadcasting, etc. The electronic apparatus can provide more convenient functions for users by the wide variety of application programs.

However, with the diversification of the application programs, data in the electronic apparatus is also proliferating, such as article data stored by the application programs of information browsing, web data stored by the application programs of web browsing, social networking data stored by the application programs of social networking, health data stored by the application programs of health care, and weather data stored by the application programs of weather broadcasting, etc. Therefore, it may be difficult for users to promptly read or access the interested contents from all the data if the data in the electronic apparatus is not classified and managed.

### SUMMARY

The following presents a simplified summary of the disclosure in order to provide a basic understanding to the reader. This summary is not an extensive overview of the disclosure and it does not identify key/critical components of the present disclosure or delineate the scope of the present disclosure. Its sole purpose is to present some concepts disclosed herein in a simplified form as a prelude to the more detailed description that is presented later:

One aspect of the present disclosure is to provide a classifying method adapted to an electronic apparatus. The classifying method includes following steps: according to frequency counts of executing plural application programs in the electronic apparatus, correspondingly creating plural data folders in at least one storage device; and classifying data in the at least one storage device into at least one of the data folders according to contents of the data.

In an embodiment of the present disclosure, wherein the step of correspondingly creating the data folders in the at least one storage device according to the frequency counts of executing the application programs further comprises: creating the data folders in the at least one storage device according to the frequency counts of executing the application programs and frequency counts of operating at least one sensor in the electronic apparatus.

In an embodiment of the present disclosure, wherein the step of correspondingly creating the data folders in the at least one storage device according to the frequency counts of executing the application programs further comprises; creating the data folders in the at least one storage device according to the frequency counts of executing the application programs and frequency counts of operating at least one wearable device.

In an embodiment of the present disclosure, the classifying method further includes generating an ordering result by sorting the data folders according to the frequency counts of executing the application programs; and displaying at least one of the data folders according to the ordering result.

In an embodiment of the present disclosure, the classifying method further includes displaying at least one corresponding recommendation age according to frequency counts of accessing the data folders.

In an embodiment of the present disclosure, wherein the at least one corresponding recommendation message comprises information of television programs, information of application programs, information of web pages or information of advertisements.

In an embodiment of the present disclosure, wherein the at least one storage device comprises a cloud storage device.

Another aspect of the present disclosure is to provide an electronic apparatus comprising a storage unit and a processing unit. The storage unit is configured for storing data. The processing unit is electrically coupled with the storage unit and configured for correspondingly creating plural data folders according to frequency counts of executing the application programs in the electronic apparatus and classifying the data into at least one of the data folders according to contents of the data.

In an embodiment of the present disclosure, the electronic apparatus further includes at least one sensor. The at least one sensor is electrically coupled with the processing unit, wherein the processing unit is further configured for correspondingly creating the data folders according to the frequency counts of executing the application programs and frequency counts of operating the at least one sensor in the electronic apparatus.

In an embodiment of the present disclosure, wherein the processing unit is further configured for correspondingly creating the data folders according to the frequency counts of executing the application programs and frequency counts of operating at least one wearable device.

In an embodiment of the present disclosure, the electronic apparatus further includes a display unit. The display is electrically coupled with the processing unit, wherein the processing unit is further configured for generating an ordering result by sorting the data folders according to the frequency counts of executing the application programs and displaying at least one of the data folders on the display unit according to the ordering result.

In an embodiment of the present disclosure, the electronic apparatus further includes a display unit. The display is electrically coupled with the processing unit, wherein the processing unit is further configured for displaying at least one corresponding recommendation message on the display unit according to frequency counts of accessing the data folders.

In an embodiment of the present disclosure, wherein the at least one corresponding recommendation message comprises information of television programs, information of application programs, information of web pages or information of advertisements.

By utilizing the present disclosure, the electronic apparatus can automatically create the corresponding data folders according to the frequency counts of executing the application programs or the frequency counts of operating the sensor/wearable device in the electronic apparatus. Then, the data in the electronic apparatus can be classified into the data folders according to contents of the data. Therefore, the user can read or search the data more conveniently. For example, the electronic apparatus can automatically classify the articles or web pages stored by the user into the corresponding data folders. While the application program of information browsing (e.g., BlinkFeed) is being executed, the electronic apparatus can display the data folders and the classified articles in the data folders, and the user can thus conveniently select and read the contents, which he/she may be interested in.

In addition, the electronic apparatus can generate an ordering result by sorting the data folders according to the frequency counts of executing the application programs, and display the data folders according to the ordering result. Therefore, the data folders and its contents, which the user may be interested in, can be displayed first according to the habits and hobbies of the user. The user can thus view the contents of interest more efficiently.

Furthermore, the electronic apparatus can display corresponding recommendation message according to frequency counts of accessing the data folders. Therefore, the information, application programs or advertisements, which the user may be interested in, can be recommended to the user according to the habits and hobbies of the user.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an electronic apparatus according to an embodiment of the present disclosure;

FIG. 2 is a schematic diagram of an electronic apparatus according to an embodiment of the present disclosure;

FIG. 3 is a schematic diagram of an electronic apparatus according to an embodiment of the present disclosure;

FIG. 4 is a schematic diagram of an electronic apparatus according to an embodiment of the present disclosure;

FIG. 5 is a schematic diagram of a classifying system according to an embodiment of the present disclosure;

FIG. 6 is a flow chart of a classifying method according to an embodiment of the present disclosure;

FIG. 7 is a flow chart of a classifying method according to an embodiment of the present disclosure;

FIG. 8 is a flow chart of a classifying method according to an embodiment of the present disclosure;

FIG. 9 is a flow chart of a classifying method according to an embodiment of the present disclosure; and

FIG. 10 is a flow chart of a classifying method according to an embodiment of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In this document, the term “coupled” may also be termed as “electrically coupled”, and the term “connected” may be termed as “electrically connected”. “coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

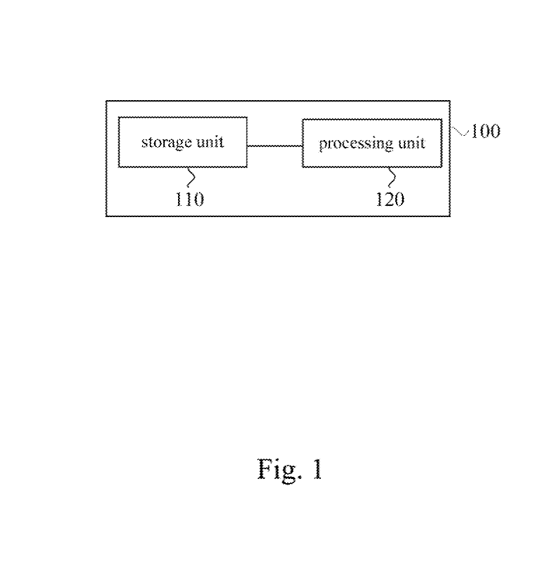

FIG. 1 is a schematic diagram of an electronic apparatus 100 according to an embodiment of the present disclosure. The electronic apparatus 100 can be a smart phone, a touch panel or a laptop but the present disclosure is not limited in this regard. The electronic apparatus 100 includes a storage unit 110 and a processing unit 120. The storage unit 110 can be a read-only memory, a flash memory or another equivalent storage unit. In one embodiment, the electronic apparatus 100 includes at least one processor and at least one memory, and the processing unit 120 is stored in the memory and executed by the processor.

The storage unit 110 is configured to store data. In one embodiment, the data can be corresponding to data stored by executing application programs in the electronic apparatus 100. In one example, the data can be article data stored by executing application programs of information browsing in the electronic apparatus 100. In another example, the data can be web data stored by executing application programs of web browsing (e.g., Chrome, Firefox or Safari) in the electronic apparatus 100. In still another example, the data can be health data stored by executing application programs of health care in the electronic apparatus 100. In yet another example, the data can be weather data stored by executing application programs of weather in the electronic apparatus 100. It should be noted that the abovementioned data can be stored manually by a user when the application programs are executed, or the data also can be stored automatically when the application programs are executed.

In another embodiment, the data can be mail data or short message data. However, the present disclosure is not limited in this regard. Those of ordinary skill in the art can decide the types of data for practical use.

The processing unit 120 is electrically coupled with the storage unit 110. The processing unit 120 is configured for creating plural data folders according to frequency counts of executing the application programs in the electronic apparatus 100 and classifying the data into at least one of the data folders according to contents of the data. In an embodiment, the abovementioned classifying the data means that the processing unit 120 stores the data into corresponding data folders in the electronic apparatus 100.

In an embodiment, processing unit 120 is configured for creating corresponding data folders according to the frequency counts of executing the application programs such as application programs of weather, application programs of health care, application programs of finance, application programs of food or application programs of media in the electronic apparatus 100. The data folders, for example, can be data folders of weather, data folders of health, data folders of heartbeat, data folders of blood pressure, data folders of finance, data folders of stock, data folders of food, data folders of media, data folders of movie or data folders of music. It should be noted that the data folders can be independent to each other or be subordinate to other data folders. For example, the data folders of weather and the data folders of health can be independent to each other, but the data folders of heartbeat and the data folders of blood pressure can be sub data folders of the data folders of health. Similarly, the data folders of stock can be sub data folders of finance, and the data folders of movie and the data folders of music can be the sub data folders of data folders of media. However, the present disclosure is not limited in this regard. Those of ordinary skill in the art can decide the types of application programs for practical use.

Then, the processing unit 120 is configured for classifying the data, which is stored by executing application programs in the electronic apparatus 100 as mentioned in above paragraph (e.g., article data, web data, social networking data, health data and weather data), into at least one of the abovementioned data folders according to contents of the data.

For example, the processing unit 120 classifies the weather data into the data folders of weather, the heartbeat data into the data folders of heartbeat, and the blood pressure data into the data folders of blood pressure. The processing unit 120 can also classify the finance related web data into the data folders of finance, the stock related article data (e.g., the stock analyses or the stock quotes) into the data folders of stock, and the food related social networking data into the data folders of food.

In one example, the processing unit 120 is configured for detecting whether the frequency counts of executing the application programs of finance are more than 7. If the frequency counts of executing the application programs of finance are more than 7, the processing unit 120 will create the data folders of finance and classify the finance date into the data folders of finance. It should be noted that the abovementioned threshold is not limited to 7, those of ordinary skill in the art can decide the number of threshold for practical use.

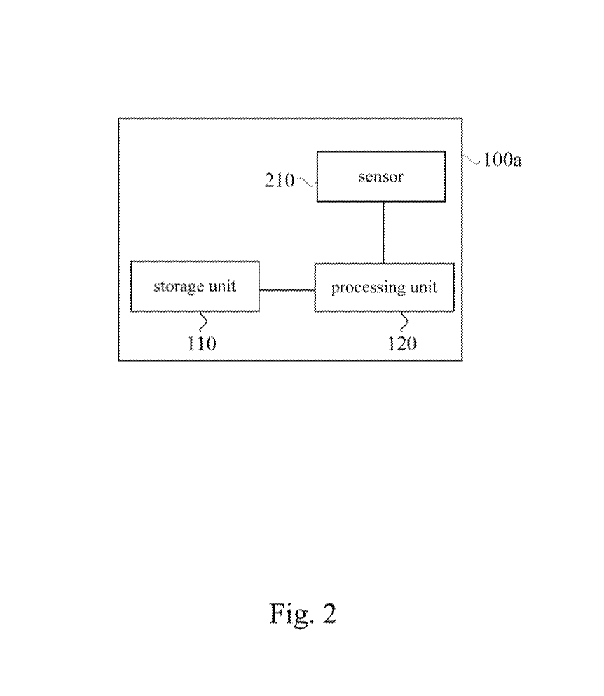

FIG. 2 is a schematic diagram of an electronic apparatus 100a according to an embodiment of the present disclosure. In this embodiment, as compared to the electronic apparatus 100 shown in FIG. 1, the electronic apparatus 100a further includes a sensor 210. The sensor 210 can be a pressure sensor, a heartbeat sensor, a GPS (global positioning system) sensor, but the present disclosure is not limited in this regard.

As shown in FIG. 2, the sensor 210 is electrically coupled with the processing unit 120, wherein the processing unit 120 is further configured for creating corresponding data folders according to the abovementioned frequency counts of executing the application programs and frequency counts of operating the sensor 210.

The processing unit 120 creates corresponding data folders according to the frequency counts of executing the application programs as described in the above embodiment, and a description in this regard will not be repeated herein. In this embodiment, the processing unit 120 is further configured for creating corresponding data folders according to the frequency counts of operating the sensor 210, which can be generated by the user through executing the related application programs.

In one example, the sensor 210 can be a pressure sensor, and the processing unit 120 is configured for creating a data folder of weather according to the frequency counts of operating the pressure sensor, which are generated by the user through executing the application programs of weather. In another example, the sensor 210 can be a body temperature sensor, and the processing unit 120 is configured for creating a data folder of body temperature according to the frequency counts of operating the body temperature sensor, which are generated by the user through executing the application programs of health care. In still another example, the sensor 210 can be a heartbeat sensor, and the processing unit 120 is configured for creating a data folder of heartbeat according to the frequency counts of operating the heartbeat sensor, which are generated by the user through executing the application programs of health care. In yet another example, the sensor 210 can be a GPS sensor, and the processing unit 120 is configured for creating a data folder of map according to the frequency counts of operating the GPS sensor, which are generated by the user through executing the application programs of map.

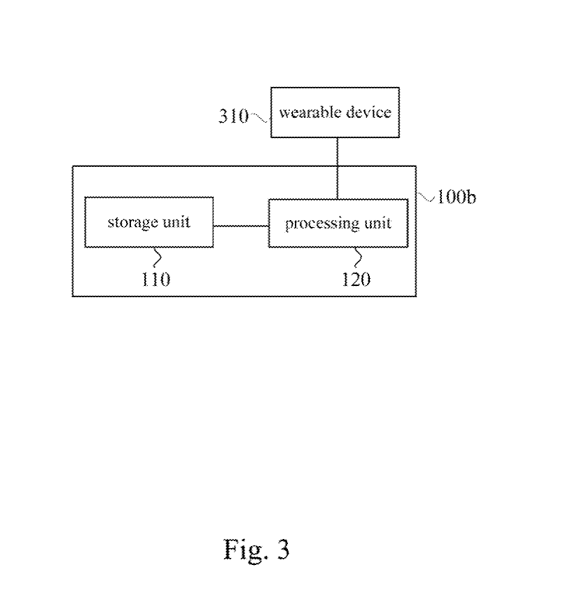

FIG. 3 is a schematic diagram of an electronic apparatus 100b according to an embodiment of the present disclosure. In this embodiment, as compared to the electronic apparatus 100 shown in FIG. 1, the processing unit 120 in the electronic apparatus 100b is further configured for creating the data folders according to the abovementioned frequency counts of executing the application programs and frequency counts of operating at least one wearable device 310. The wearable device 310 can be a pedometer, a blood pressure meter, a heartbeat meter, a glucose meter or a thermometer.

The processing unit 120 creates corresponding data folders according to the frequency counts of executing the application programs as described in the above embodiment, and a description in this regard will not be repeated herein. In this embodiment, the processing unit 120 is further configured for creating corresponding data folders according to the frequency counts of operating the wearable device 310, which can be generated by the user through executing the related application programs.

In one example, the wearable device 310 can be a pedometer, and the processing unit 120 is configured for creating a data folder of sport according to the frequency counts of operating the pedometer, which are generated by the user through executing the application programs of sport. In another example, the wearable device 310 can be a blood pressure meter, and the processing unit 120 is configured for creating a data folder of blood pressure according to the frequency counts of operating the blood pressure meter, which are generated by the user through executing the application programs of blood pressure measurement. In still another example, the wearable device 310 can be a heartbeat meter, and the processing unit 120 is configured for creating a data folder of heartbeat according to the frequency counts of operating the heartbeat meter, which are generated by the user through executing the application programs of heartbeat measurement.

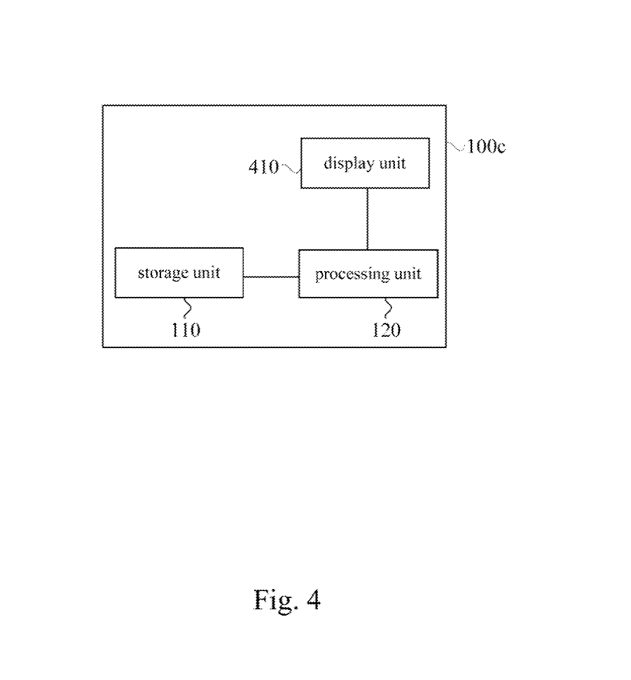

FIG. 4 is a schematic diagram of an electronic apparatus 100c according to an embodiment of the present disclosure. In this embodiment, as compared to the electronic apparatus 100 shown in FIG. 1, the electronic apparatus 100c further includes a display unit 410 electrically coupled with the processing unit 120. The display unit 410 can be a touch panel but not limited in this regard.

In one embodiment, the processing unit 120 is further configured for generating an ordering result by sorting the abovementioned data folders according to the frequency counts of executing the application programs and displaying at least one of the data folders on the display unit 410 according to the ordering result. That is to say, while an application program is being executed, the processing unit 120 displays portions or all of the data folders on the display unit 410. In one example, the frequency counts of executing the application programs of weather, health care, finance and food are respectively 10, 5, 7, and 3. The processing unit 120 sorts the abovementioned frequency counts of executing the application programs (e.g., sorts the amount of frequency counts in descending order like 10, 7, 5, 3), and sequentially displays the data folders of weather, finance, health care, and food on the display unit 410 while an application program of information browsing (e.g., BlinkFeed) is being executed.

In another embodiment, the processing unit 120 displays only one of the data folders on the display unit 410 while an application program is being executed. In one example, the processing unit 120 displays the data folder of health on the display unit 410 while the application program of health care is executed.

In still another embodiment, the processing unit 120 is further configured for displaying at least one corresponding recommendation message on the display unit 410 according to frequency counts of accessing the data folders. The abovementioned recommendation message can be information of television programs, information of application programs, information of web pages or information of advertisements.

In one example, the processing unit 120 displays the recommended information of television programs on the display unit 410 according to the frequency counts of accessing the data folders of media. Therefore, the user can watch the television programs, which he/she may be interested in, on the electronic apparatus 100c according to the recommended information of television programs. In another example, the processing unit 120 displays the recommended information of application programs of health care (e.g., application programs of weight management, application programs of calorie calculation, application programs of heartbeat measurement, etc.) on the display unit 410 according to the frequency counts of accessing the data folders of health. Therefore, the user can execute the application programs of health care, which he/she may be interested in, on the electronic apparatus 100c according to the recommended information of application programs. In still another example, the processing unit 120 displays the recommended information of web pages of finance on the display unit 410 according to the frequency counts of accessing the data folders of finance. Therefore, the user can browse the finance related web pages, which he/she may be interested in, on the electronic apparatus 100c according to the recommended information of web pages.

In one example, the processing unit 120 is configured for detecting whether the frequency counts of accessing the data folders of media are more than 5. If the frequency counts of accessing the data folders of media are more than 5, the processing unit 120 will display the recommended information of television programs on the display unit 410.

In the abovementioned embodiment, the storage unit is set up inside the electronic apparatus. However, in the present disclosure, the storage unit does not have to be set up inside the electronic apparatus, the storage unit can also be set up as an independent storage device.

In addition, the storage unit and the electronic apparatus both can be plural. In one embodiment, the storage unit can be plural cloud storage devices (e.g., Dropbox, Google Drive, iCloud or MS OneDrive), and the plural electronic apparatuses can access data from those cloud storage devices through Internet.

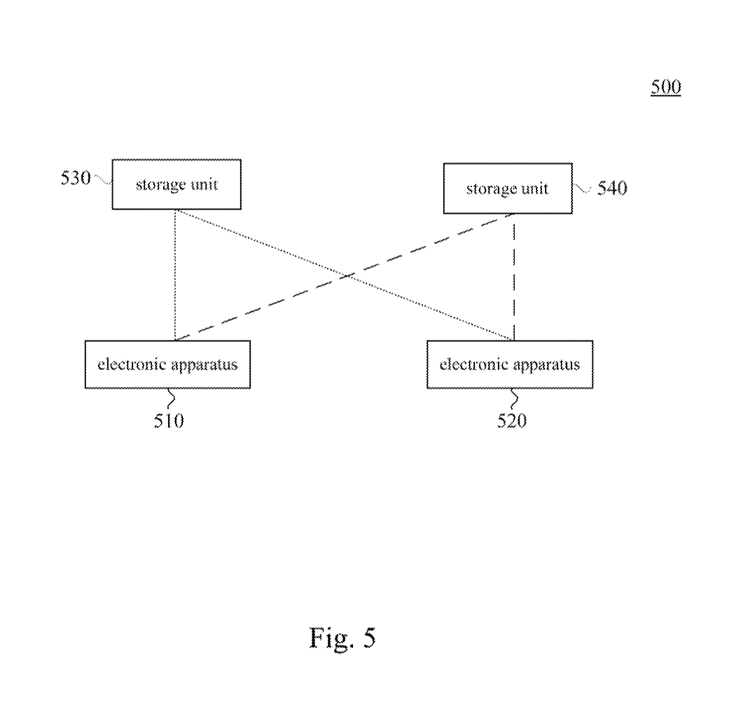

FIG. 5 is a schematic diagram of a classifying system 500 according to an embodiment of the present disclosure. The classifying system 500 includes electronic apparatuses 510, 520 and storage devices 530, 540. The storage devices 530, 540 can be cloud storage devices but not limited in this regard.

It should be noted that the amounts of the abovementioned storage devices and the electronic apparatuses are not limited to 2 as shown in FIG. 5. Those of ordinary skill in the art can determine the amounts for practical use. In FIG. 5, the operation between electronic apparatuses 510, 520 and the storage devices 530, 540 is analogous to the operation between the processing unit 120 and the storage device 110 in FIG. 1˜FIG. 4, and so a description in this regard will not be repeated herein.

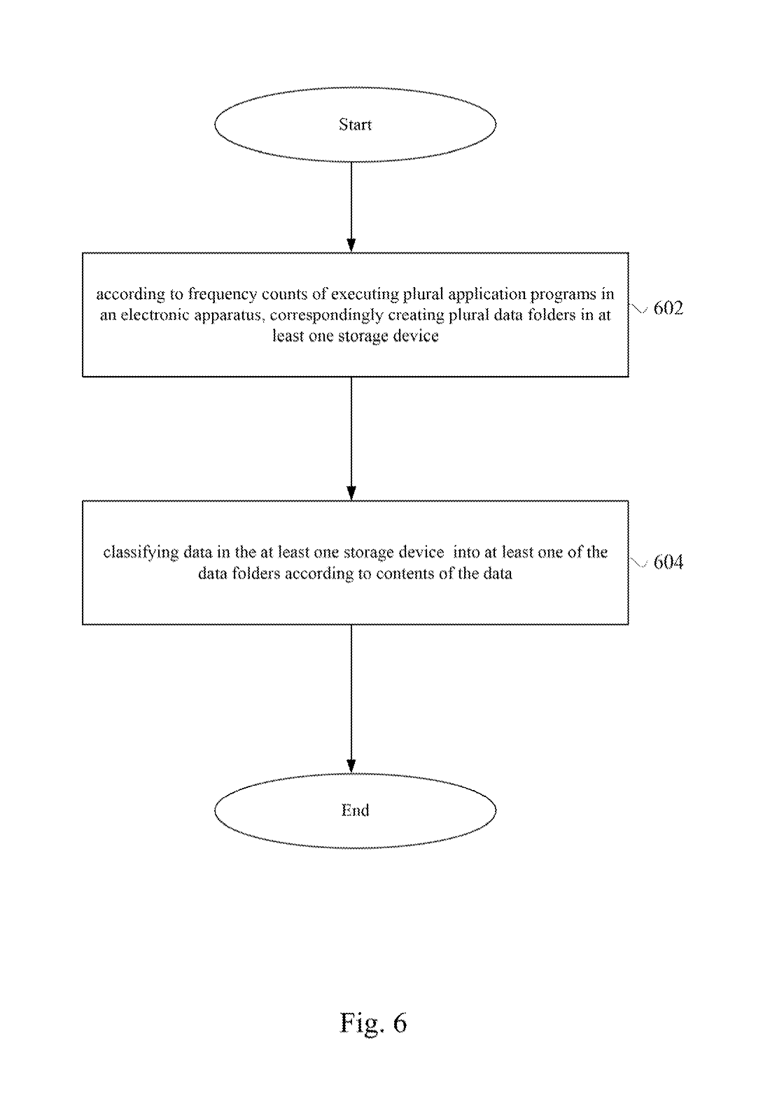

FIG. 6 is a flow chart of a classifying method according to an embodiment of the present disclosure. The classifying method is adapted to the classifying system 500 illustrated in FIG. 5 but not limited in this regard. To clearly clarify, the following description is stated for the classifying system 500 as shown in FIG. 5.

In step 602, according to frequency counts of executing plural application programs in an electronic apparatus (510 or 520), plural data folders are correspondingly created in at least one storage device (530 or 540).

In step 604, data in the at least one storage device is classified into at least one of the data folders according to contents of the data.

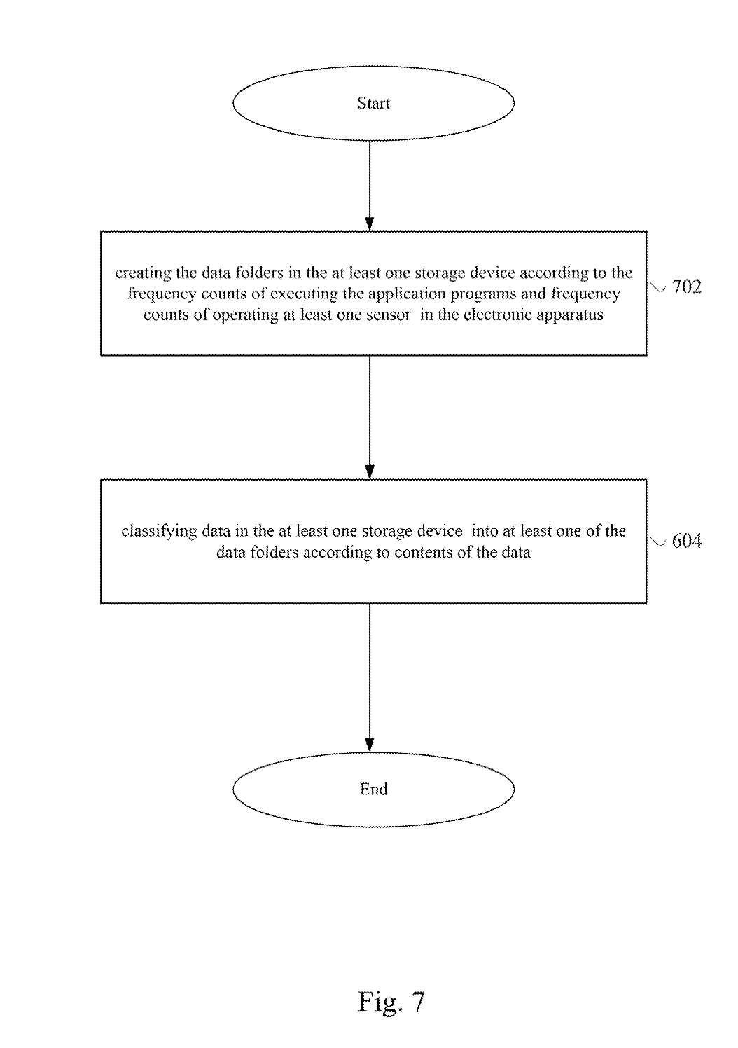

FIG. 7 is a flow chart of a classifying method according to an embodiment of the present disclosure. The classifying method is adapted to the classifying system 500 illustrated in FIG. 5 but not limited in this regard. To clearly clarify, the following description is stated for the classifying system 500 as shown in FIG. 5.

In step 702, the data folders are created in the at least one storage device (530 or 540) according to the frequency counts of executing the application programs and frequency counts of operating at least one sensor (not shown in figure) in the electronic apparatus (510 or 520).

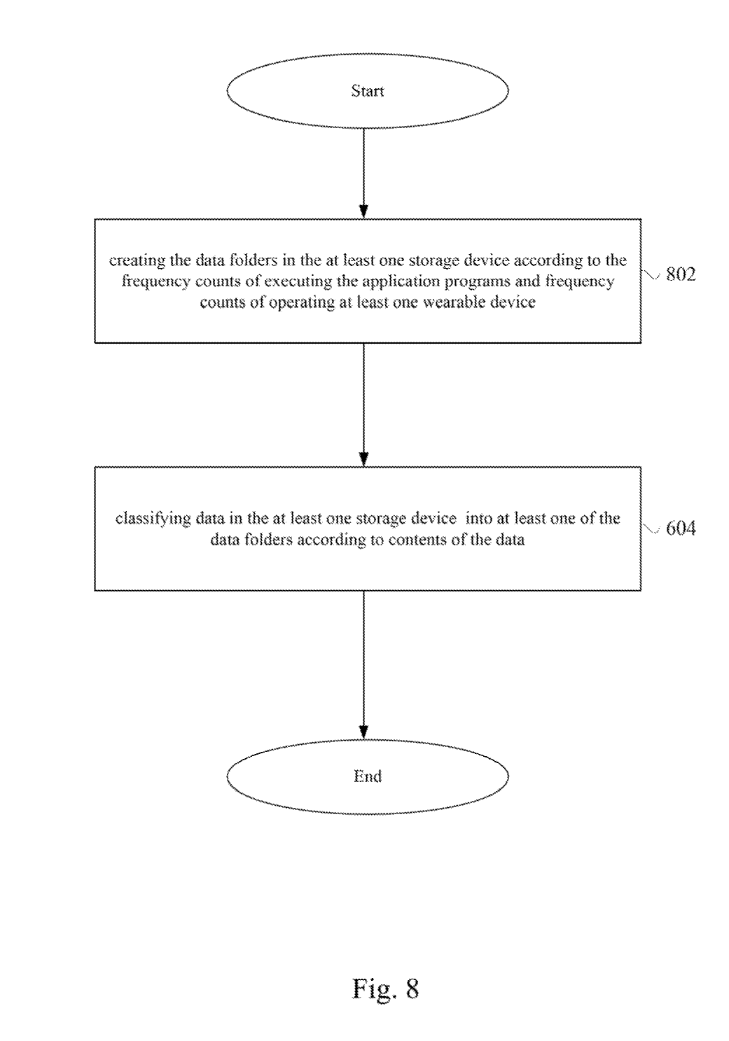

FIG. 8 is a flow chart of a classifying method according to an embodiment of the present disclosure. The classifying method is adapted to the classifying system 500 illustrated in FIG. 5 but not limited in this regard. To clearly clarify, the following description is stated for the classifying system 500 as shown in FIG. 5.

In step 802, the data folders are created in the at least one storage device (530 or 540) according to the frequency counts of executing the application programs and frequency counts of operating at least one wearable device (not shown in figure).

Description of Step 604 is the same as above, and so a description in this regard will not be repeated herein.

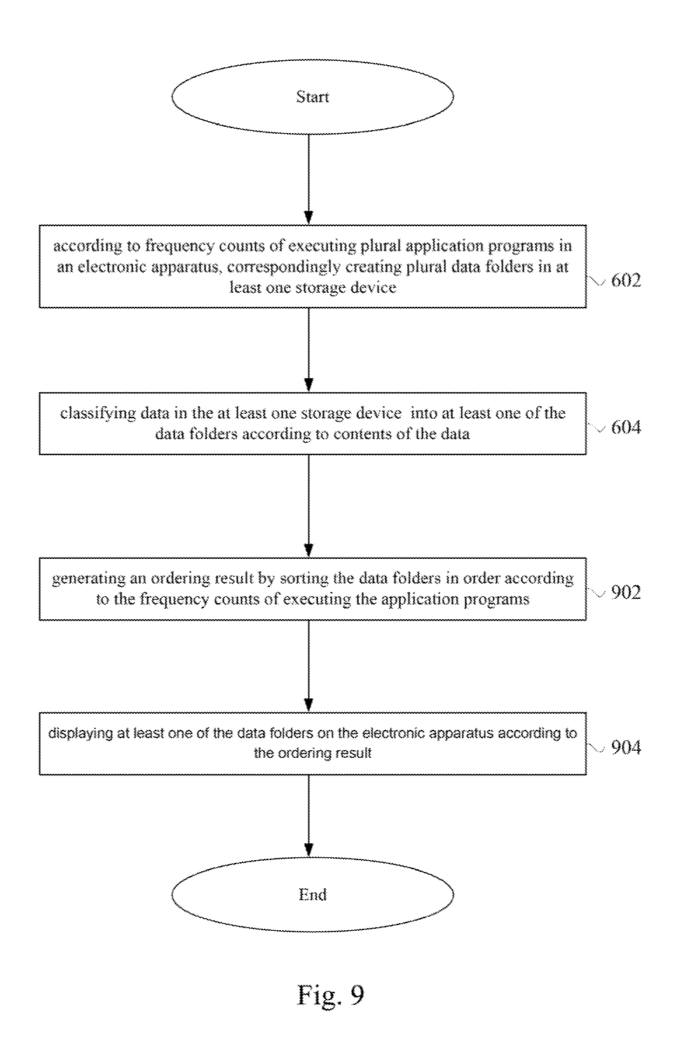

FIG. 9 is a flow chart of a classifying method according to an embodiment of the present disclosure. In this embodiment, as compared to the classifying method shown in FIG. 6, the classifying method further includes step 902 and step 904. The classifying method is adapted to the classifying system 500 illustrated in FIG. 5 but not limited in this regard. To clearly clarify, the following description is stated for the classifying system 500 as shown in FIG. 5.

In step 902, an ordering result is generated by sorting the data folders according to the frequency counts of executing the application programs.

In step 904, at least one of the data folders is displayed on the electronic apparatus (510 or 520) according to the ordering result.

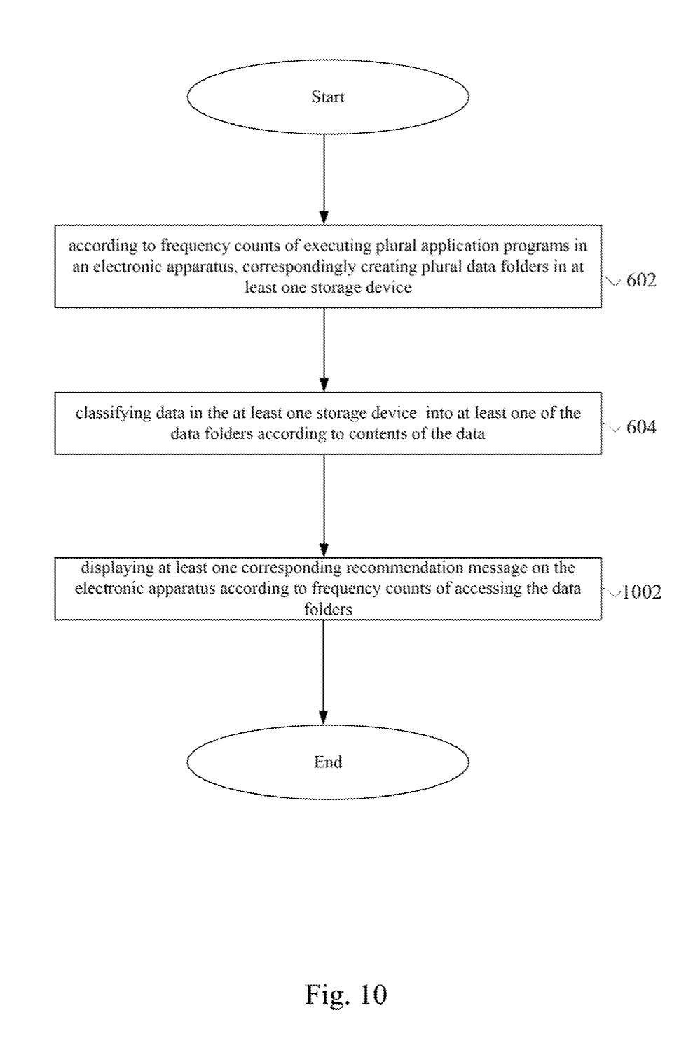

FIG. 10 is a flow chart of a classifying method according to an embodiment of the present disclosure. In this embodiment, as compared to the classifying method shown in FIG. 6, the classifying method further includes step 1002. The classifying method is adapted to the classifying system 500 illustrated in FIG. 5 but not limited in this regard. To clearly clarify, the following description is stated for the classifying system 500 as shown in FIG. 5.

In step 1002, at least one corresponding recommendation message is displayed on the electronic apparatus (510 or 520) according to frequency counts of accessing the data folders. In one embodiment, the corresponding recommendation message can be information of television programs, information of application programs, information of web pages or information of advertisements.

It should be understood that the order of the steps in the abovementioned embodiments can be changed for practical use.

To summarize, by utilizing the present disclosure, the electronic apparatus can automatically create the corresponding data folders according to the frequency counts of executing the application programs or the frequency counts of operating the sensor/wearable device in the electronic apparatus. Then, the data in the electronic apparatus can be classified into the data folders according to contents of the data. Therefore, the user can read or search the data more conveniently. For example, the electronic apparatus can automatically classify the articles or web pages stored by the user into the corresponding data folders. While the application program of information browsing (e.g., BlinkFeed) is being executed, the electronic apparatus can display the data folders and the classified articles in the data folders, and the user can thus conveniently select and read the contents, which he/she may be interested in.

In addition, the electronic apparatus can generate an ordering result by sorting the data folders according to the frequency counts of executing the application programs, and display the data folders according to the ordering result. Therefore, the data folders and its contents, which the user may be interested in, can be displayed first according to the habits and hobbies of the user. The user can thus view the contents of interest more efficiently.

Furthermore, the electronic apparatus can display corresponding recommendation message according to frequency counts of accessing the data folders. Therefore, the information, application programs or advertisements, which the user may be interested in, can be recommended to the user according to the habits and hobbies of the user.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A classifying method adapted to an electronic apparatus, comprising:
correspondingly creating plural data folders in at least one storage device according to frequency counts of executing plural application programs in the electronic apparatus; and
classifying data in the at least one storage device into at least one of the data folders according to contents of the data.

2. The classifying method of claim 1, wherein the step of correspondingly creating the data folders in the at least one storage device according to the frequency counts of executing the application programs further comprises:
creating the data folders in the at least one storage device according to the frequency counts of executing the application programs and frequency counts of operating at least one sensor in the electronic apparatus.

3. The classifying method of claim 1, wherein the step of correspondingly creating the data folders in the at least one storage device according to the frequency counts of executing the application programs further comprises:
creating the data folders in the at least one storage device according to the frequency counts of executing the application programs and frequency counts of operating at least one wearable device.

4. The classifying method of claim 1, further comprising:
generating an ordering result by sorting the data folders according to the frequency counts of executing the application programs; and
displaying at least one of the data folders according to the ordering result.

5. The classifying method of claim 1, further comprising:
displaying at least one corresponding recommendation message according to frequency counts of accessing the data folders.

6. The classifying method of claim 5, wherein the at least one corresponding recommendation message comprises information of television programs, information of application programs, information of web pages or information of advertisements.

7. The classifying method of claim 1, wherein the at least one storage device comprises a cloud storage device.

8. An electronic apparatus, comprising:
a storage unit, configured for storing data; and
a processing unit electrically coupled with the storage unit, the processing unit being configured for correspondingly creating plural data folders according to frequency counts of executing the application programs in the electronic apparatus and classifying the data into at least one of the data folders according to contents of the data.

9. The electronic apparatus of claim 8, further comprising:
at least one sensor electrically coupled with the processing unit, wherein the processing unit is further configured for correspondingly creating the data folders according to the frequency counts of executing the application programs and frequency counts of operating the at least one sensor in the electronic apparatus.

10. The electronic apparatus of claim 8, wherein the processing unit is further configured for correspondingly creating the data folders according to the frequency counts of executing the application programs and frequency counts of operating at least one wearable device.

11. The electronic apparatus of claim 8, further comprising:
a display unit electrically coupled with the processing unit, wherein the processing unit is further configured for generating an ordering result by sorting the data folders according to the frequency counts of executing the application programs and displaying at least one of the data folders on the display unit according to the ordering result.

12. The electronic apparatus of claim 8, further comprising:
a display unit electrically coupled with the processing unit, wherein the processing unit is further configured for displaying at least one corresponding recommendation message on the display unit according to frequency counts of accessing the data folders.

13. The electronic apparatus of claim 12, wherein the at least one corresponding recommendation message comprises information of television programs, information of application programs, information of web pages or information of advertisements.
